(19) United States
(12) Patent Application Publication
(10) Pub. No.: US 2012/0135214 A1
(43) Pub. Date: May 31, 2012

(54) Sorbent For Removal Of A Contaminant From A Fluid

(76) Inventors: Steven Bruce Dawes, Corning, NY (US); Benedict Yorke Johnson, Horseheads, NY (US); Millicent Kaye Weldon Ruffin, Painted Post, NY (US); Elizabeth Marie Vileno, Corning, NY (US); Ezra Morgan Yarnell, Corning, NY (US)

(21) Appl. No.: 13/279,555

(22) Filed: Oct. 24, 2011

Related U.S. Application Data
(60) Provisional application No. 61/418,033, filed on Nov. 30, 2010.

(51) Int. Cl. B01D 53/02; B01D 53/82; B01D 53/81; B01J 20/28; C09K 3/00

(52) U.S. Cl. 428/219; 95/90; 502/400; 502/406; 502/401; 252/184; 423/210

(57) ABSTRACT

Active materials, for example, metal sulfide, or metal selenide which may be useful in the removal of a contaminant from a fluid.

### CROSS-REFERENCE To RELATED APPLICATION

This application claims the benefit of priority under 35 U.S.C. §119 of U.S. Provisional Application Ser. No. 61/418,033, filed on Nov. 30, 2010, the content of which is relied upon and incorporated herein by reference.

### FIELD OF THE DISCLOSURE

The disclosure relates to active materials, for example, metal sulfide, or metal selenide which may be useful in the removal of a contaminant from a fluid.

### BACKGROUND

Multiple approaches to adsorbing the vapor phase mercury from coal fired power plants are of interest to the industry to meet the regulations in a cost efficient way.

A leading technology is the use of activated carbon injected (ACI) into the flue gas stream, whereupon after several seconds to minutes of presence in the gas stream it is extracted and treated as waste. Activated carbon is known to efficiently adsorb mercury from a gas, but is susceptible to rapid saturation, and some reversible desorption. As a technique ACI has several problems: the valuable fly ash product can be compromised by the injected carbon; the method is effective, but rather costly as the quantities of carbon are large; and the injection process requires attention in operation.

### SUMMARY

Disclosed herein are articles and methods which utilize active materials, for example, metal sulfide, or metal selenide, which may be useful in the removal of a contaminant from a fluid. One advantage of the embodiments disclosed herein is that a high surface area component is not required to capture a contaminant from a fluid. For example, the active material need not be supported by a high surface area substrate and the active material itself does not have a high surface area.

Embodiments disclosed herein include a flow-through article comprising an active material, wherein the active material has a surface area less than 20 m²/g, and wherein the active material is selected from a metal sulfide, a metal selenide, or combinations thereof. In some embodiments, disclosed is a flow-through article comprising an active material, wherein the active material has a surface area less than 20 m²/g, wherein the active material is selected from a metal sulfide, a metal selenide, or combinations thereof, and wherein the active material is supported by a substrate having a surface area less than 100 m²/g. In some embodiments, the substrate is essentially free of activated carbon or comprises no activated carbon.

Also disclosed is a method of making a flow-through article comprising an active material having a surface area less than 20 m²/g, the method comprising dispersing the active material in a packed bed, wherein the active material is selected from a metal sulfide, a metal selenide, or combinations thereof.

Also disclosed is a method of making a flow-through article comprising an active material having a surface area less than 20 m²/g, the method comprising applying a coating comprising a solution or suspension of the active material to a substrate, wherein the active material is selected from a metal sulfide, a metal selenide, or combinations thereof.

Also disclosed is a method of removing a contaminant from a fluid, the method comprising providing a flow-through article comprising an active material having a surface area less than 20 m²/g, wherein the active material is selected from a metal sulfide, a metal selenide, or combinations thereof, and contacting the fluid comprising a contaminant with the flow-through article.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

### DETAILED DESCRIPTION

Disclosed herein are low surface area active materials useful, for example, for capturing a contaminant from a fluid. Also disclosed herein are active materials having a surface area less than 20 m²/g, also referred to herein as “low surface area” active materials. The active material may be selected from a metal sulfide, a metal selenide, and combinations thereof. In some embodiments, the active material comprises one or more metal sulfides. In some embodiments, the active material comprises one or more metal selenides. In some embodiments, the active material comprises a combination of one or more metal sulfides and one or more metal selenides.

Embodiments disclosed herein comprise a metal sulfide, wherein the metal may include, for example, alkali metal, alkaline earth metals, and transition metals. Example metal sulfides include sulfides of transition metals such as iron, manganese, copper, nickel, cadmium, silver, thallium, and zinc.

The metal sulfide itself has a surface area ranging from 0.1 m²/g to 20 m²/g. In some embodiments, the metal sulfide has a surface area of 20 m²/g or less, 15 m²/g or less, 5 m²/g or less, 2 m²/g or less, 1 m²/g or less, or 0.5 m²/g or less. In some embodiments, the metal sulfide has a median particle size of from 0.1 microns to 10 microns, for example 0.1 microns to 1 micron, 0.5 microns to 1 microns, 0.1 microns to 5 microns.

Also disclosed herein are metal selenides useful, for example, for capturing a contaminant from a fluid. Some embodiments comprise a metal selenide, wherein the metal may include, for example, alkali metal, alkaline earth metals, and transition metals. Example metal selenides include selenides of transition metals such as iron, manganese, copper, nickel, cadmium, silver, thallium, and zinc.

The metal selenide itself has a surface area ranging from 0.1 m²/g to 20 m²/g. In some embodiments, the metal sulfide has a surface area of 20 m²/g or less, 15 m²/g or less, 5 m²/g or less, 2 m²/g or less, 1 m²/g or less, or 0.5 m²/g or less. In some embodiments, the metal selenide has a median particle size of from 0.1 microns to 10 microns, for example 0.1 microns to 1 micron, 0.5 microns to 1 microns, 0.1 microns to 5 microns.

In some embodiments, the flow-through article consists essentially of the active material, for example, as a powder, particles, granules, beads, ball, pellets, trilobes, or other suitable forms. In some embodiments, the flow-through article comprises a packed bed comprising an active material. In some embodiments, the packed bed comprises beads, trilobes, or other suitable materials. In some embodiments, the active material may be coated on beads, particles, granules, trilobes, pellets, or other substrates in a packed bed. In some embodiments, the active material may be coated on a substrate, such as a honeycomb.

The term “flow-through article” as used herein is an article comprising inner passageways, such as straight or serpentine channels and/or porous networks that would permit the flow of a fluid stream through the article. The flow-through article comprises a dimension in the flow-through direction of at least 1 cm, at least 2 cm, at least 3 cm, at least 4 cm, at least 5 cm, at least 6 cm at least 7 cm, at least 8 cm, at least 9 cm, or at least 10 cm from the inlet to the outlet.

In some embodiments, the substrate is a rolled, corrugated steel or metallic foil. In some embodiments, the substrate has a honeycomb structure comprising an inlet end, an outlet end, and inner channels extending from the inlet end to the outlet end. In one embodiment, the honeycomb comprises a multiplicity of cells extending from the inlet end to the outlet end, the cells being defined by intersecting cell walls. The honeycomb substrate could optionally comprise one or more selectively plugged honeycomb substrate cell ends to provide a wall flow-through structure that allows for more intimate contact between the fluid stream and cell walls.

Exemplary substrates in any of the embodiments include substrates comprising a glass, glass-ceramic, ceramic, metal, polymer, or inorganic cement, including combinations thereof. Some example substrate materials include cordierite, mullite, clay, magnesia, metal oxides, talc, zircon, zirconia, zirconates, zirconia-spinel, magnesium alumino-silicates, spinel, zeolite, alumina, silica, silicates, borides, alumina-titanate, alumino-silicates, e.g., porcelains, lithium aluminosilicates, alumina silica, feldspar, titania, fused silica, nitrides (e.g. silicon nitride), borides, carbides (e.g. silicon carbide), silicon nitride, metal sulfates, metal carbonates or metal phosphates (wherein the metal can be, for example, Ca, Mg, Al, B, Fe, Ti, Zn), or combinations of these.

Exemplary substrates in any of the embodiments may also include polymer substrates. The polymer substrates may be linear or cross-linked and may include, for example, organic polymers, such as epoxies, polyamides, polyimides or phenolic resins, or silicone polymers, such as methyl or phenyl silicones, and combinations thereof.

In some embodiments, the substrate is nonporous. In some embodiments, the substrate comprises a surface having a surface area of 400 m²/g or less, 300 m²/g or less, 200 m²/g or less, 100 m²/g or less or 50 m²/g or less.

The substrate may be made using any suitable technique. For example, a honeycomb substrate may be made by preparing a batch mixture, extruding the mixture through a die forming a honeycomb shape, drying, and optionally firing the substrate.

The batch mixture can be comprised, for example, of a combination of inorganic batch materials sufficient to form a desired sintered phase ceramic composition including, for example, a predominant sintered phase composition comprised of ceramic, glass-ceramic, glass and combinations thereof. It should be understood that, as used herein, combinations of glass, ceramic, and/or glass ceramic compositions includes both physical and/or chemical combinations, e.g., mixtures or composites. Exemplary batch mixture materials include, for example, glass, glass-ceramic, ceramic, or inorganic cement materials mentioned above in the context of the composition of the substrate. In some embodiments the batch mixture may comprise oxide glass; oxide ceramics; or other refractory materials. Exemplary and non-limiting inorganic materials suitable for use in an inorganic batch mixture can include oxygen-containing minerals or salts, clay, zeolites, talc, cordierite, titanates, aluminum titanate, mullite, magnesium oxide sources, zircon, zirconates, zirconia, zirconia spinel, spinel, alumina forming sources, including aluminas and their precursors, silica forming sources, including silicas and their precursors, silicates, aluminates, aluminosilicates, kaolin, flyash, lithium aluminosilicates, alumina silica, aluminosilicate fibers, magnesium aluminum silicates, alumina trihydrate, feldspar, boehmite, attapulgites, titania, fused silica, nitrides, carbides, carbonates, borides, (e.g. silicon carbide, silicon nitride), or combinations of these.

It should be understood that the inorganic batch mixture may further comprise a binder. The binder may include organic binders, inorganic binders, or a combination of both. Suitable organic binders include water soluble cellulose ether binders such as methylcellulose, ethylhydroxy ethylcellulose, hydroxybutylcellulose, hydroxybutyl methylcellulose, hydroxyethylcellulose, hydroxymethylcellulose, hydroxypropylcellulose, hydroxypropyl methylcellulose, hydroxyethyl methylcellulose, sodium carboxy methylcellulose, methylcellulose derivatives, hydroxyethyl acrylate, polyvinylalcohol, or combinations thereof.

In some embodiments, the substrate may comprise fibrous fillers, for example, ceramic, glass or metal fibers or whiskers.

One liquid vehicle for providing a flowable or paste-like consistency to the batch mixture is water, although it should be understood that other liquid vehicles exhibiting solvent action with respect to suitable temporary organic binders could be used. The amount of the liquid vehicle component can vary in order to impart optimum handling properties and compatibility with other components in the batch mixture.

In addition to a liquid vehicle and binder, the batch mixture can also comprise one or more optional forming or processing aids. Exemplary forming or processing aids or additives can include lubricants, ionic surfactants, plasticizers, and sintering aids. Exemplary lubricants can include hydrocarbon acids, such as, stearic acid or oleic acid, sodium stearate, petroleum oils with molecular weights from about 250 to 1000, containing paraffinic and/or aromatic and/or alicyclic compounds, household oils, synthetic oils based on poly (alpha olefins), esters, polyalkylene glycols, polybutenes, silicones, polyphenyl ether, CTFE oils, and other commercially available oils. Vegetable oils such as sunflower oil, sesame oil, peanut oil, soybean oil etc. are also useful. An exemplary plasticizer can include glycerine.

In some embodiments, the substrate is essentially free of activated carbon. In some embodiments, the substrate comprises no activated carbon. In other embodiments, the substrate comprises less than 10%, less than 5%, less than 2%, less than 1%, or less than 0.1% by weight of activated carbon.

Embodiments disclosed herein include a substrate coated with a coating that comprises an active material such as a metal sulfide, metal selenide, or combinations thereof. The term “coating” as used herein means that an active material is disposed on an exposed surface of the substrate. The coating may coat all or a portion of the surface of the substrate, and may impregnate the substrate to some extent if the surface of the substrate is porous. For instance, the coating may coat the inner channel surfaces of honeycomb substrate and any outer surfaces of the honeycomb substrate. In some embodiments, the active material is in the form of an uninterrupted and continuous coating over all or a portion of the exposed surfaces of the substrate. In other embodiments, the coating of active material comprises cracks, pinholes, or other discontinuities. In some embodiments, portions of the exposed surfaces of the substrate remain uncoated.

Embodiments comprise a substrate coated with a metal sulfide. The metal may include, for example, alkali metal, alkaline earth metals, and transition metals. Example metal sulfides include sulfides of transition metals such as iron, manganese, copper, nickel, cadmium, silver, thallium, and zinc.

The metal sulfide itself has a surface area ranging from 0.1 m²/g to 20 m²/g. In some embodiments, the metal sulfide has a surface area of 20 m²/g or less, 15 m²/g or less, 5 m²/g or less, 2 m²/g or less, 1 m²/g or less, or 0.5 m²/g or less. In some embodiments, the metal sulfide has a median particle size of from 0.1 microns to 10 microns, for example 0.1 microns to 1 micron, 0.5 microns to 1 microns, 0.1 microns to 5 microns.

Embodiments comprise a substrate coated with a metal selenide. The metal may include, for example, alkali metal, alkaline earth metals, and transition metals. Example metal sulfides include sulfides of transition metals such as iron, manganese, copper, nickel, cadmium, silver, thallium, and zinc.

The metal selenide itself has a surface area ranging from 0.1 m²/g to 20 m²/g. In some embodiments, the metal sulfide has a surface area of 20 m²/g or less, 15 m²/g or less, 5 m²/g or less, 2 m²/g or less, 1 m²/g or less, or 0.5 m²/g or less. In some embodiments, the metal selenide has a median particle size of from 0.1 microns to 10 microns, for example 0.1 microns to 1 micron, 0.5 microns to 1 microns, 0.1 microns to 5 microns.

In some embodiments, the flow-through article comprises one or more metal sulfides, one or more metal selenides, or combinations of one or more metal sulfides and one or more metal selenides.

In some embodiments, the flow-through article is essentially free of activated carbon. In some of those embodiments, the flow-through article comprises no activated carbon. In other of those embodiments, the flow-through article comprises less than 10%, less than 5%, less than 3%, less than 1%, or less than 0.1% by weight of activated carbon.

The flow-through article may be made using suitable techniques. In one embodiment, the flow-through article may be made by a method which comprises providing a substrate and coating the substrate with an active material. The substrate may be coated with the active material using suitable techniques such as by applying a washcoat comprising a solution or suspension of the active material to the substrate. As examples, the active material can be applied by dipping the substrate in a solution or suspension comprising the active material or spraying a solution or suspension comprising the active material on the substrate or utilizing a vacuum to “draw” the solution comprising the active material into and through a substrate.

The amount of active material retained by the substrate can be increased, for example, by contacting the substrate with the active material more than once and allowing the substrate to dry between contacting steps. In addition, the amount of active material retained by the substrate can be controlled by selecting an appropriate overall porosity of the substrate, for example, higher porosity will increase the amount of active material retained by the substrate.

The active materials disclosed herein may be used, for example, for the sorption of a contaminant from a fluid stream through contact with the fluid. In some embodiments, the active materials may be injected as particulates into a fluid stream, without being supported by a substrate.

In some embodiments, particles of the active materials may be dispersed in a packed bed, or coated on substrate particles in a packed bed. In some embodiments, particles of the active materials may be formed, pressed, or shaped into beads, ball, trilobes, or pellets for dispersal in a packed bed.

In some embodiments, the active materials may be disposed on a substrate. For example, a fluid stream may be passed through inner passageways of a flow-through article from the inlet end to the outlet end. The fluid stream may be in the form of a gas or a liquid. The gas or liquid may also contain another phase, such as a solid particulate in either a gas or liquid stream, or droplets of liquid in a gas stream. Example gas streams include coal combustion flue gases (such as from bituminous and sub-bituminous coal types or lignite coal) and syngas streams produced in a coal gasification process.

As used herein, the terms “sorb,” “sorption,” and “sorbed,” refer to the adsorption, sorption, or other entrapment of the contaminant on the flow-through article, either physically, chemically, or both physically and chemically.

Contaminants that may be sorbed include, for instance, contaminants at 3 wt % or less of the fluid stream, for example at 2 wt % or less, or 1 wt % or less. Contaminants may also include, for instance, contaminants at 10,000 μg/m³ or less within the fluid stream. Example contaminants include heavy metals. The term “heavy metal” and any reference to a particular metal by name herein includes the elemental forms as well as oxidation states of the metal. Sorption of a heavy metal thus includes sorption of the elemental form of the metal as well as sorption of any organic or inorganic compound or composition comprising the metal.

Example heavy metals that can be sorbed include cadmium, mercury, chromium, lead, barium, beryllium, and chemical compounds or compositions comprising those elements. For example, the metal mercury may be in an elemental)(Hg° or oxidized state (Hg⁺ or Hg²⁺). Example forms of oxidized mercury include HgO and halogenated mercury, for example Hg₂Cl₂ and HgCl₂. Other exemplary metallic contaminants include nickel, cobalt, vanadium, zinc, copper, manganese, antimony, silver, and thallium, as well as organic or inorganic compounds or compositions comprising them. Additional contaminants include arsenic and selenium as elements and in any oxidation states, including organic or inorganic compounds or compositions comprising arsenic or selenium.

The contaminant may be in any phase that can be sorbed on the flow-through article. Thus, the contaminant may be present, for example, as a liquid in a gas fluid steam, or as a liquid in a liquid fluid stream. The contaminant could alternatively be present as a gas phase contaminant in a gas or liquid fluid stream.

Various embodiments will be further clarified by the following examples.

### EXAMPLE 1

Zinc sulfide powder was exposed to simulated flue gas at 150° C. The zinc sulfide powder was not supported by a substrate, and in particular, not supported by a high surface area support. The gas mixture containing SO₂ 400 ppm, HCl 5 ppm, NO 200 ppm, 6% O₂, 12% CO₂, 15% H₂O, 20 ng/1 Hg with the balance N₂ was impinged on a sample of 0.157 g ZnS powder (sourced from Alfa Aesar) blended with 1.0 g silica beads and packed into a glass tube with quartz wool plugs. The gas flow rate was 750 ml/min, which is nominally equivalent to a 30,000 h⁻¹ space velocity. The mercury levels were measured with PSA test system. Inlet mercury levels were measured periodically, and outlet levels measured over 17 days of flow. The test showed mercury adsorption efficiency of >100% over most of the 17 day run. On day 14 of the run the gas mixture was modified by the addition of 20 ppm NO₂. The mercury adsorption performance with addition of NO₂ was essentially unchanged. Possible flue gas environments include low levels of ozone. On day 16 of the run, the gas mixture was modified by the addition of 6-20 ppm ozone. Upon addition of ozone a mercury spike was measured in the outlet level, but subsequent measurements over the course of a day again showed ˜100% mercury capture efficiency, demonstrating oxidative durability of the zinc sulfide powder. A similar sample was tested in high SO₂ conditions and showed mercury adsorption efficiency at >90%.

### EXAMPLE 2

Manganese sulfide powder was tested under similar conditions to Example 1. 10 mg of MnS was dispersed in 1 g of silica beads. In this example the mercury adsorption was lower because of the small amount of material in the test, but remained steady at 60% efficiency for several hours of testing. This result was surprising as it was previously believed that MnS alone would not function as a mercury adsorber.

### EXAMPLE 3

Copper sulfide powder was tested under similar conditions to Example 1. 0.1576 g of CuS were supported on silica beads with the same simulated gas flows. The performance showed 100 to 80% mercury adsorption over 10 days of testing. The mercury capture efficiency of CuS was lower than ZnS. CuS is known to be more stable under acidic conditions, therefore it is believed that the CuS stability could lessen mercury capture efficiency. Stability could be beneficial for long lifetime and maximal mercury capacity of the flow-through article.

Articles and methods disclosed herein provide a stationary solution, as a flow-through article would be placed into the fluid stream and efficiently capture the mercury over an extended period of time. The operational cost would be reduced, and the fly ash product would not be contaminated by the flow-through article.

The articles and methods disclosed also provide one or more of the desired qualities of a mercury adsorber, for example, 1) durable and high efficiency mercury adsorption, 2) a low interaction with other flue gas chemistries to avoid complexity that arises with flue gas composition shifts, 3) a simple adsorption architecture that requires fewer process steps to achieve, and 4) a low cost manufacturing platform that can produce quantities sufficient for gigawatt facilities without enormous capital expenditures.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A flow-through article comprising:
an active material having a surface area less than 20 m²/g;
wherein the active material is selected from a metal sulfide, a metal selenide, or combinations thereof.

2. The flow-through article of claim 1, wherein the active material has a surface area less than 2 m²/g.

3. The flow-through article of claim 1, wherein the active material comprises particles having a median particle size of 0.1 microns to 10 microns.

4. The flow-through article of claim 3, wherein the active material particles have a median particle size of 0.1 microns to 1 micron.

5. The flow-through article of claim 1, wherein the active material is supported on a substrate.

6. The flow-through article of claim 1, wherein the metal sulfide is a sulfide of zinc, copper, manganese, iron, nickel, cadmium, silver, or thallium.

7. The flow-through article of claim 1, wherein the metal selenide is a selenide of zinc, copper, manganese, iron, nickel, cadmium, silver, or thallium.

8. The flow-through article of claim 5, wherein the substrate comprises a glass, glass-ceramic, ceramic, metal, or polymer.

9. The flow-through article of claim 5, wherein the substrate has a surface area less than 100 m²/g.

10. The flow-through article of claim 5, wherein the substrate in nonporous.

11. The flow-through article of claim 1, wherein the active material is dispersed in a packed bed.

12. The flow-through article of claim 1, wherein the flow-through article is essentially free of activated carbon.

13. The flow-through article of claim 1, wherein the flow-through article is essentially free of zeolite.

14. The flow-through article of claim 1, wherein the flow-through article is essentially free of a binder.

15. A method of removing a contaminant from a fluid, the method comprising:
providing a flow-through article comprising:
an an active material having a surface area less than 20 m²/g;
wherein the active material is selected from a metal sulfide, a metal selenide, or combinations thereof; and
contacting the fluid comprising a contaminant with the flow-through article.

16. The method of claim 15, wherein the active material is supported on a substrate.

17. The method of claim 15, wherein the active material is dispersed in a fixed bed.

18. A flow-through article comprising:
an active material having a surface area less than 20 m²/g;
wherein the active material is selected from a metal sulfide, a metal selenide, or combinations thereof; and
wherein the flow-through article removes mercury from a fluid stream at greater than 90 percent efficiency when the flow-through article is exposed to the fluid stream at 150° C. for greater than 10 days.
